(19) United States
(12) Patent Application Publication
(10) Pub. No.: US 2025/0222676 A1
(43) Pub. Date: Jul. 10, 2025

(54) PROTECTIVE FILM-EQUIPPED WRITING-PERFORMANCE ENHANCEMENT FILM

(71) Applicant: LINTEC Corporation, Tokyo (JP)

(72) Inventors: Minami NAKANISHI, Tokyo (JP); Hiroki HOSHINO, Tokyo (JP)

(73) Assignee: LINTEC Corporation, Tokyo (JP)

(21) Appl. No.: 18/852,945

(22) PCT Filed: Dec. 2, 2022
(86) PCT No.: PCT/JP2022/044509

§ 371 Date: Sep. 30, 2024

(30) Foreign Application Priority Data
Mar. 31, 2022 (JP) 2022-061139

(51) Int. Cl. B32B 7/12; B32B 27/08; B32B 27/16; B32B 27/30; B32B 27/36; B32B 33/00

(52) U.S. Cl. CPC B32B 7/12; B32B 27/08; B32B 27/16; B32B 27/308; B32B 27/365; B32B 33/00; B32B 2250/02; B32B 2307/30

(57) ABSTRACT

Provided is a protective film-equipped writing feel improving film which is formed by laminating a protective film on at least one surface of a writing feel improving film having a writing feel improving film base material layer and a writing feel improving layer, in which given that a linear expansion coefficient of the writing feel improving film is α (×10⁻⁵/K) and a linear expansion coefficient of the protective film is β (×10⁻⁵/K), the following formula is satisfied: −6.5<(α−β)<6.5. According to the disclosure, there is provided a protective film-equipped writing feel improving film, which does not curl even due to temperature changes during storage, transportation, processing, and the like and maintains the quality of the writing feel improving film.

### TECHNICAL FIELD

The present disclosure relates to a protective film-equipped writing feel improving film in which a protective film is laminated on a writing feel improving film for improving the writing feel on a touch panel or the like with a touch pen.

### BACKGROUND ART

In recent years, image display devices (touch panels) having a position detection function and serving both as a display device and as an input means are widely used in various electronic devices.

In such touch panels, it has been considered to attach a film for improving the writing feel (referred to as a “writing feel improving film,” hereinafter) with a touch pen to the outermost surface of the touch panel.

Disclosed writing feel improving films include a writing feel improving film having a writing feel improving layer with a specific frictional force (Patent Literature 1), an anti-glare hard coat film for touch panels with pen tip resistance of a touch pen and oleic acid contact angle regulated (Patent Literature 2), a transparent film having a specific total luminous transmittance and a specific maximum height of rolling circle waviness profile (Patent Literature 3), a tactile film containing linear convex portions forming a network structure (Patent Literature 4), and a transparent laminated film having a surface profile with a specific maximum height of rolling circle waviness profile and arithmetic mean roughness (Patent Literature 5).

However, these documents do not describe a laminate in which a protective film is laminated on a writing feel improving film.

### CITATION LIST

### Patent Literature

Patent Literature 1: WO2020/122172 (US2022/0033600A1)
Patent Literature 2: Unexamined Japanese Patent Application Publication No. 2014-232276A
Patent Literature 3: Unexamined Japanese Patent Application Publication No. 2014-97649A (US2015/0291828A1)
Patent Literature 4: Unexamined Japanese Patent Application Publication No. 2015-54417A
Patent Literature 5: Unexamined Japanese Patent Application Publication No. 2016-196113A (US2018/0030229A1)

### SUMMARY OF INVENTION

### Technical Problem

After being produced, a writing feel improving films is stored, transported, processed, and the like. Therefore, a protective film may be attached (laminated) to the surface of the writing feel improving film in order to protect the surface of the film until the writing feel improving film is used in a touch panel.

A writing feel improving film having a protective film laminated on its surface (hereinafter referred to as a “protective film-equipped writing feel improving film”) may be exposed to high temperatures (40° C. to 60° C.) for a long period during storage or transportation or may be processed under high temperatures (50° C. to 90° C.) during processing. Such temperature changes cause the film to curl, which can lead to a problem of degraded quality of the writing feel improving film.

The present disclosure has been made in consideration of such actual circumstances and an object of the present disclosure is to provide a protective film-equipped writing feel improving film that is prevented from curling due to a temperature change.

### Solution to Problem

The present inventors conducted intensive studies on the protective film-equipped writing feel improving film to solve the problem above. As a result, the present inventors found that the problem can be solved by setting the linear expansion coefficient α (×10⁻⁵/K) of the writing feel improving film and the linear expansion coefficient β (×10⁻⁵/K) of the protective film to have a specific relationship. This has led to the completion of the present disclosure.

Thus, according to the present disclosure, the protective film-equipped writing feel improving films of the following [1] to [6] are provided.

(1) A protective film-equipped writing feel improving film which is formed by laminating a protective film on at least one surface of a writing feel improving film having a writing feel improving film base material layer and a writing feel improving layer,
wherein given that a linear expansion coefficient of the writing feel improving film is α (×10⁵/K) and a linear expansion coefficient of the protective film is β (×10⁻⁵/K), the following formula is satisfied: −6.5<(α−β)<6.5.

(2) The protective film-equipped writing feel improving film according to (1), wherein the protective film is laminated on a surface of the writing feel improving layer of the writing feel improving film.

(3) The protective film-equipped writing feel improving film according to (1) or (2), wherein the protective film has an adhesive layer and a protective film base material layer, and at least one surface of the writing feel improving film is laminated on the adhesive layer of the protective film so as to be in contact therewith.

(4) The protective film-equipped writing feel improving film according to (1) or (2), wherein given that a linear expansion coefficient of the writing feel improving film is α (×10⁻⁵/K) and a linear expansion coefficient of the protective film is β (×10⁻⁵/K), the following formula is satisfied: −1.0<(α−β)<1.0.

(5) The protective film-equipped writing feel improving film according to (1) or (2), wherein the linear expansion coefficient α (×10⁻⁵/K) of the writing feel improving film is 1.5 to 8.0 (×10⁻⁵/K).

(6) The protective film-equipped writing feel improving film according to (1) or (2), wherein a delamination force between the writing feel improving film and the protective film is 800 mN/25 mm or less.

### Advantageous Effect of Invention

According to the protective film-equipped writing feel improving film of the present disclosure, the writing feel improving film is prevented from curling due to a temperature change during storage, transportation, processing, or the like, maintaining the quality of the writing feel improving film.

### BRIEF DESCRIPTION OF DRAWINGS

FIG. 1 is a schematic diagram illustrating an example of the layer structure of the protective film-equipped writing feel improving film of the present disclosure; and

FIG. 2 is a diagram illustrating the maximum curl height.

### DESCRIPTION OF EMBODIMENTS

The protective film-equipped writing feel improving film of the present disclosure is a protective film-equipped writing feel improving film which is formed by laminating a protective film on at least one surface of a writing feel improving film having a writing feel improving film base material layer and a writing feel improving layer, wherein given that a linear expansion coefficient of the writing feel improving film is α (×10⁻⁵/K) and a linear expansion coefficient of the protective film is β (×10⁻⁵/K), the following formula is satisfied: −6.5<(α−β)<6.5.

Hereinafter, the protective film-equipped writing feel improving film of the present disclosure is described in detail.

### 1) Writing Feel Improving Film

The writing feel improving film according to the present embodiment has a writing feel improving film base material layer and a writing feel improving layer.

### (1) Writing Feel Improving Film Base Material Layer

The writing feel improving film base material layer according to the present embodiment has the role of carrying the writing feel improving layer.

As the material for the writing feel improving film base material layer, a transparent material can be appropriately selected from conventionally known materials as base materials.

Examples of such materials include polyesters films such as a polyethylene terephthalate film, a polybutylene terephthalate film, and a polyethylene naphthalate film, polyolefin films such as a polyethylene film and a polypropylene film, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a polyimide film a fluorine resin film, a polyamide film, an acrylic resin film, a polyurethane resin film, a norbornene-based polymer film, a cyclic olefin-based polymer film, a cyclic conjugated diene-based polymer film, a vinyl alicyclic hydrocarbon polymer film, a polyphenylene sulfide film, a liquid crystal polymer film; cellophane; glass; and laminated films thereof.

Among these, a polyethylene terephthalate film, a polycarbonate film, an acrylic resin film, a norbornene-based polymer film, and the like are preferred from the viewpoint that they can well maintain the writing feel with a touch pen in combination with the writing feel improving layer, and a polyethylene terephthalate polycarbonate film, a polymethyl methacrylate film, and a composite base material thereof are particularly preferred.

For the purpose of improving the interfacial adhesion between the writing feel improving film base material layer and a layer provided on the surface of the writing feel improving film base material layer (such as the writing feel improving layer or an adhesive layer), if desired, one surface or both surfaces of the base material can be subjected to surface treatment, such as by an oxidation method or a roughening method, a primer treatment, or the like.

Examples of the oxidation method include corona discharge treatment, plasma discharge treatment, chromic acid treatment (wet method), flame treatment, hot-air treatment, and ozone/ultraviolet treatment.

Examples of the roughening method include a sandblast method and a solvent treatment method.

The primer treatment can be carried out by a known method, such as coating the surface of the writing feel improving film base material layer with an adhesive resin material.

These surface treatments may be appropriately selected depending on the material of the base material layer.

The thickness of the writing feel improving film base material layer is preferably 30 to 300 μm, more preferably 90 to 250 μm, particularly preferably 120 to 220 μm, and further preferably 150 to 200 μm, from the viewpoints of adequately supporting the writing feel improving layer, processability, protection of a touch panel, and resistance to writing with a touch pen.

### (2) Writing Feel Improving Layer

The writing feel improving layer according to the present embodiment has a function of improving the writing feel with a touch pen.

Here, “improving the writing feel with a touch pen” means that in the case of writing on the writing feel improving layer with a touch pen, the feeling of vibration that occurs when writing with a ballpoint pen on paper (feeling of vibration) can be reproduced, and the feeling of resistance (degree of friction) that occurs when writing with a ballpoint pen on paper can be reproduced (feeling of resistance).

The writing feel improving layer can be formed using a composition for forming a writing feel improving layer.

A composition for forming a writing feel improving layer can be prepared by, for example, mixing a curable component, fine particles, a surface conditioner, and the like.

### (2-1) Curable Component

The composition for forming a writing feel improving layer according to the present embodiment is preferably one containing a curable component as a main component.

The curable component is a component that is cured by active energy rays such as visible light, ultraviolet light, and an electron beam, or by heat or the like. Examples thereof include an active energy ray-curable component and a heat-curable component.

In particular, it is preferable to use an active energy ray-curable component from the viewpoints of the hardness of the writing feel improving layer formed, the heat resistance of the writing feel improving film base material layer, and the like, and of exerting the effect of lowering the linear expansion coefficient α of the writing feel improving film. A writing feel improving film provided with such a writing feel improving layer tends to exhibit an excellent curling suppression effect when combined with a protective film.

Examples of the active energy ray-curable component include a polyfunctional (meth)acrylate monomer, a (meth)acrylate prepolymer, and an active energy ray-curable polymer. Among these, a polyfunctional (meth)acrylate monomer and/or a (meth)acrylate prepolymers are preferred, and a polyfunctional (meth)acrylate monomer is more preferred since they have a predetermined hardness and can achieve an improved writing feel with a touch pen. When combined with a protective film, a writing feel improving layer using such a material tends to exhibit an excellent curling suppression effect.

The polyfunctional (meth)acrylate monomer and the (meth)acrylate prepolymer may be used alone or in combination.

Herein, the term “(meth)acrylate” means an acrylate and/or methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl) isocyanurate, pentaerythritol tetra(meth)acrylate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates.

These can each be used alone or two or more types can also be used in combination.

Examples of the (meth)acrylate-based prepolymer include polyester acrylate-based, epoxy acrylate-based, urethane acrylate-based, and polyol acrylate-based prepolymers.

The polyester acrylate-based prepolymer can be obtained through preparing a polyester oligomer having hydroxyl groups at both ends obtained by condensation of a polycarboxylic acid and a polyalcohol and esterifying the hydroxyl groups of the polyester oligomer with (meth)acrylic acid, or through preparing an oligomer obtained by adding an alkylene oxide to a polycarboxylic acid and esterifying the hydroxyl group at an end of the oligomer with (meth)acrylic acid.

The epoxy acrylate-based prepolymer can be obtained through reacting (meth)acrylic acid with the oxirane ring of a relatively low-molecular-weight bisphenol-type epoxy resin or novolak-type epoxy resin to esterify it.

The urethane acrylate-based prepolymer can be obtained through preparing a polyurethane oligomer obtained by a reaction between a polyether polyol or a polyester polyol and a polyisocyanate and esterifying the polyurethane oligomer with (meth)acrylic acid.

The polyol acrylate-based prepolymer can be obtained through esterifying a hydroxyl group of a polyether polyol with (meth)acrylic acid.

The prepolymers can each be used alone or two or more types can also be used in combination.

### (2-2) Fine Particles

The composition for forming a writing feel improving layer according to the present embodiment preferably contains fine particles. By containing fine particles, the surface of the writing feel improving layer formed can be a moderately rough surface so that the average value, maximum value, minimum value, and standard deviation of the frictional force described below can be readily adjusted within the desired ranges. As a result, with obtained writing feel improving film, moderate feelings of friction and vibration can be developed when writing on the writing feel improving layer with a touch pen, making it possible to well reproduce the writing feel experienced when writing on paper with a ballpoint pen. In addition, the linear expansion coefficient α of the writing feel improving film can be readily reduced, and particularly when combined with a protective film, an excellent curling suppression effect tends to be exhibited.

The above-described fine particles refer to particles having an average particle diameter larger than that of the silica nanoparticles described below. For example, the average particle diameter of the fine particles is preferably 1 to 20 μm, more preferably 3 to 18 μm, particularly preferably 6 to 16 μm, further preferably 8 to 14 μm, and among these, preferably 10 to 12 μm. By using microparticles having an average particle diameter within the above-described range, the average value, maximum value, minimum value, and standard deviation of the frictional force described below can be readily adjusted within the desired ranges, thereby imparting moderate feelings of friction and vibration to the writing feel improving layer. This makes it possible to well reproduce the writing feel experienced when writing on paper with a ballpoint pen. In addition, the linear expansion coefficient α of the writing feel improving film can be readily reduced, and particularly when combined with a protective film, an excellent curling suppression effect tends to be exhibited.

The above-described average particle diameter of the fine particles refers to values measured with a laser diffraction and scattering-type particle diameter distribution measurement device using a few drops of a dispersion liquid as a sample. The dispersion liquid may be prepared with methyl ethyl ketone as a dispersion medium and may have a concentration of 5% by mass.

The above fine particles may be inorganic fine particles, organic fine particles, or resin fine particles having both inorganic and organic properties. In particular from the viewpoints of the hardness of the writing feel improving layer formed and of making it easier to lower the linear expansion coefficient α of the writing feel improving film, the inorganic fine particles or resin fine particles having both inorganic and organic properties are preferred, and the resin fine particles having both inorganic and organic properties are particularly preferred.

Examples of the inorganic fine particles include fine particles composed of silica, alumina, titania, zirconia, tin oxide, indium oxide, cadmium oxide, antimony oxide, and the like. Among these, the silica fine particles are preferred.

Examples of organic fine particles include melamine-based resin fine particles, acrylic-based resin fine particles (such as polymethyl methacrylate resin fine particles), acrylic-styrene copolymer fine particles, polycarbonate-based fine particles, polyethylene-based fine particles, polystyrene-based fine particles, and benzoguanamine-based resin fine particles. The resin constituting the resin fine particles may be crosslinked. Among these, from the viewpoints of optical properties and hardness, acrylic-based resin fine particles are preferred, and polymethyl methacrylate resin fine particles are more preferred.

Preferred examples of resin fine particles having both inorganic and organic properties include silicone fine particles (for example, Tospearl series available from Momentive Performance Materials Japan).

In order to further improve dispersibility, it is also preferable that the surfaces of the fine particles are modified with a surface modifier.

In addition, the shape of the fine particles may be spherical or non-spherical. In the case of a non-spherical shape, the shape may be an indefinite shape or a shape with a high aspect ratio, such as a needle shape or a scale shape. In this specification, the term “indefinite shape” refers to a shape having many irregular corners or faces rather than a regular shape such as a sphere or an ellipse.

From the viewpoints of making it easier to adjust the average value, maximum value, minimum value, and standard deviation of the frictional force described below of the resulting writing feel improving layer within the desired ranges and of making it easier to lower the linear expansion coefficient α of the writing feel improving film, the shape of the microparticles is preferably spherical and particularly preferably genuinely spherical.

The fine particles can each be used alone or two or more types can also be used in combination.

The content of the microparticles in the composition for forming a writing feel improving layer is preferably 0.1 to 20 parts by mass, more preferably 0.5 to 17 parts by mass, particularly preferably 1 to 14 parts by mass, further preferably 3 to 12 parts by mass, and of these, preferably 6 to 11 parts by mass with respect to 100 parts by mass of the curable component. Since the content of the fine particles is within the above-described range, the average value, maximum value, minimum value, and standard deviation of the frictional force described below can be readily adjusted within the desired ranges for the resulting writing feel improving layer. In addition, the linear expansion coefficient α of the writing feel improving film can be readily reduced, and particularly when combined with a protective film, an excellent curling suppression effect tends to be exhibited.

### (2-3) Surface Conditioner

The composition for forming a writing feel improving layer according to the present embodiment preferably contains a surface conditioner.

When the composition for forming a writing feel improving layer contains a surface conditioner, generation of streaky defects, unevenness, and the like can be suppressed in the writing feel improving layer formed. This allows the film thickness to be uniform, and the writing feel improving film can have a more excellent appearance and can readily have desired optical properties (such as the haze value and the total luminous transmittance). Moreover, since the surface of the writing feel improving layer of the writing feel improving film tends to have an excellent surface condition, the average value, maximum value, minimum value, and standard deviation of the frictional force described below can be adjusted within the desired ranges, thereby making the writing feel of the writing feel improving layer even more excellent. In addition, the linear expansion coefficient α of the writing feel improving film can be readily reduced, and particularly when combined with a protective film, an excellent curling suppression effect tends to be exhibited.

Examples of the surface conditioner include a silicone-based surface conditioner consisting of a silicone-based polymer, a fluorine-based surface conditioner consisting of a fluorine-based polymer, an acrylic-based surface conditioner consisting of an acrylic-based polymer, and a vinyl-based surface conditioner consisting of a vinyl polymer.

Here, the silicone-based polymer means a polymer mainly consisting of polysiloxane chains, and the fluorine-based polymer means a polymer having a fluorine-substituted monomer as a main monomer unit. The acrylic-based polymer means a polymer having an acrylic acid ester as a main monomer unit. The vinyl-based polymer means a polymer having a vinyl group-containing monomer as a main monomer unit.

The surface conditioners can each be used alone or two or more types can also be used in combination.

Among these, the silicone-based surface conditioner and the fluorine-based surface conditioner may be preferred from the viewpoint of the surface conditioning properties and the compatibility with other components.

The silicone-based surface conditioner may preferably be a surface conditioner consisting of polydimethylsiloxane or modified polydimethylsiloxane and may particularly preferably be a surface conditioner consisting of polydimethylsiloxane.

A preferred fluorine-based surface conditioner is a surface conditioner consisting of a fluoropolymer having a perfluoroalkyl group or a fluorinated alkenyl group in the main chain or a side chain. Examples of commercially available products include, but are not limited to, BYK-340 available from BYK Japan KK., Ftergent 650A available from NEOS COMPANY LIMITED, Megafac RS-75 available from DIC, Megafac RS-90 available from DIC, and V-8FM available from OSAKA ORGANIC CHEMICAL INDUSTRY LTD.

In a case in which the composition for forming a writing feel improving layer contains a surface conditioner, the content of the surface conditioner in the composition for forming a writing feel improving layer is preferably 0.01 to 10 parts by mass, more preferably 0.1 to 5 parts by mass, particularly preferably 0.5 to 3 parts by mass, and further preferably 0.8 to 2 parts by mass with respect to 100 parts by mass of the curable component. Since the content of the surface conditioner is within the above-described range, the appearance of the writing feel improving film can be even more excellent. Moreover, the average value, maximum value, minimum value, and standard deviation of the frictional force described below can be readily adjusted within the desired ranges so that the writing feel of the writing feel improving layer can be even more excellent.

### (2-5) Other Components

The composition for forming a writing feel improving layer may further contain other components in addition to the above ingredients. Examples of such other components include silica nanoparticles, a photopolymerization initiator, an ultraviolet absorber, an antioxidant, a light stabilizer, an antistatic, a silane coupling agent, an antiaging agent, a thermal polymerization inhibitor, a surfactant, a storage stabilizer, a plasticizer, a glidant, an antifoam, an organic-based filler, a wettability improving agent, and a coating surface improving agent.

When the composition for forming a writing feel improving layer contains silica nanoparticles, the hardness and scratch resistance of the writing feel improving layer formed can be effectively improved, facilitating a contribution to suppressing curling. In addition, the optical properties (haze value, total luminous transmittance, and the like) of the writing feel improving film can be improved, and the occurrence of glare when the writing feel improving film is used can be effectively suppressed.

The average particle diameter of silica nanoparticles is preferably 1 to 300 nm, more preferably 5 to 100 nm, and particularly preferably 10 to 50 nm.

The average particle diameter of silica nanoparticles can be measured by a laser diffraction and scattering-type particle diameter distribution measurement device.

The silica nanoparticles may be in the form of an organosol (colloidal form). When the silica nanoparticles are in the form of an organosol, the dispersibility of the silica nanoparticles may be satisfactory, and the homogeneity and light transmittance of the writing feel improving layer formed may be improved.

In a case in which the composition for forming a writing feel improving layer contains silica nanoparticles, the content of the silica nanoparticles in the composition for forming a writing feel improving layer is preferably 5 to 50 parts by mass, more preferably 10 to 35 parts by mass, and particularly preferably 15 to 25 parts by mass with respect to 100 parts by mass of the curable component.

By setting the compounding ratio of the silica nanoparticles within the above-described range, the homogeneity and light transmittance of the writing feel improving layer formed can be maintained at higher levels.

In a case in which the composition for forming a writing feel improving layer contains an active energy ray-curable component as a curable component, a photopolymerization initiator may also be preferably contained. When a photopolymerization initiator is contained, the curing reaction caused by irradiation with active energy rays can proceed more readily.

Examples of the photopolymerization initiator used include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, and p-dimethylaminobenzoic ester. These can each be used alone or two or more types can also be used in combination.

In a case in which the composition for forming a writing feel improving layer contains a photopolymerization initiator, the content of the photopolymerization initiator in the composition for forming a writing feel improving layer is preferably 1 to 20 parts by mass and more preferably 2 to 10 parts by mass with respect to 100 parts by mass of the curable component from the viewpoint of the effect of adding the photopolymerization initiator.

The composition for forming a writing feel improving layer may contain a solvent for improvement of coating properties, adjustment of viscosity, adjustment of solid content concentration, and the like.

The solvent used is not particularly limited, provided that it dissolves curable components and the like and disperses fine particles and the like. Specific examples of the solvent include alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and Y-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as N,N-dimethylformamide, N,N-dimethylacetamide, and N-methylpyrrolidone.

The solvents can each be used alone or two or more types can also be used in combination.

The content of the solvent is preferably from 10 to 300 parts by mass and more preferably from 30 to 200 parts by mass with respect to 100 parts by mass of the curable component.

### (3) Method of Forming Writing Feel Improving Layer

The writing feel improving layer can be formed by applying the composition for forming a writing feel improving layer on the writing feel improving film base material layer to a desired thickness and drying and curing the resulting coating film.

The method for applying the composition for forming a writing feel improving layer may be a conventionally known application method, such as a bar coating method, a knife coating method, a roll coating method, a blade coating method, a die coating method, or a gravure coating method.

The drying temperature for the coating film of the composition for forming a writing feel improving layer obtained is usually 40° C. to 120° C., and the drying time is usually about 30 seconds to 5 minutes.

In a case in which the curable component in the composition for forming a writing feel improving layer has active energy ray curability, the coating film of the composition for forming a writing feel improving layer may be cured by irradiating the coating film with active energy rays such as ultraviolet rays and electron rays.

Irradiation with ultraviolet rays can be performed using a high-pressure mercury lamp, an H lamp available from Heraeus K. K., a xenon lamp, or the like, and the irradiance level of ultraviolet rays may be preferably about 50 to 1,000 mW/cm² as the illuminance and about 50 to 1,000 mJ/cm² as the light amount and more preferably about 100 to 500 mW/cm² as the illuminance and about 100 to 500 mJ/cm² as the light amount.

Irradiation with electron rays can be performed using an electron ray accelerator or the like, and the irradiance level of electron rays may be preferably about 10 to 1,000 krad.

In a case in which the curable component in the composition for forming a writing feel improving layer has thermosetting properties, the coating film of the composition for forming a writing feel improving layer may be cured by heating the coating film at a specified temperature for a specified time.

The thickness of the writing feel improving layer formed is not particularly limited, but is preferably 0.8 to 30 μm, more preferably 1 to 20 μm or more, particularly preferably 2 to 15 μm, further preferably 3 to 12 μm, and among these, preferably 4 to 10 μm, and most preferably 5 to 8 μm. The thickness of the writing feel improving layer is within the above-described range. This makes it possible to well reproduce the writing feel experienced when writing on paper with a ballpoint pen. In addition, the linear expansion coefficient α of the writing feel improving film can be readily reduced, and particularly when combined with a protective film, an excellent curling suppression effect tends to be exhibited.

The protective film-equipped writing feel improving film according to the present disclosure is required to have a linear expansion coefficient α (×10⁻⁵/K) of the writing feel improving film satisfying the formula: −6.5<(α−β)<6.5 in relation to the linear expansion coefficient β (×10⁻⁵/K) of the protective film described below. The linear expansion coefficient α of the writing feel improving film is not particularly limited as long as it satisfies the formula: −6.5<(α−β)<6.5 in relation to the linear expansion coefficient β (×10⁻⁵/K) of the protective film described later, but is usually more than 0 and not more than 50 (×10⁻⁵/K), preferably 1 to 30 (×10⁻⁵/K), more preferably 1.3 to 10 (×10⁻⁵/K), and particularly preferably 1.5 to 8 (×10⁻⁵/K). This makes it easier to satisfy the above-described formula.

The linear expansion coefficient α of the writing feel improving film can be calculated by measuring the expansion and contraction in the longitudinal direction of a test piece having a width of 4.5 mm and a length of 15 mm at a temperature increase rate of 5° C./min in a range of 30° C. to 70° C. using a thermomechanical analyzer.

In order to obtain a protective film-equipped writing feel improving film that satisfies the above formula, a protective film having an appropriate linear expansion coefficient in relation to the writing feel improving film used may be selected.

The average frictional force between the writing feel improving film (writing feel improving layer surface) and the touch pen (stylus pen) when writing is preferably 100 to 1200 mN, more preferably 200 to 800 mN, particularly preferably 250 to 500 mN, and further preferably 300 to 400 mN.

The maximum value of the frictional force between the writing feel improving film (writing feel improving layer surface) and the touch pen (stylus pen) during writing is preferably 200 to 1500 mN, more preferably 250 to 1000 mN, and further preferably 300 to 600 mN.

The minimum value of the frictional force between the writing feel improving film (writing feel improving layer surface) and the touch pen (stylus pen) when writing is preferably 80 to 1200 mN, more preferably 120 to 1000 mN, particularly preferably 200 to 700 mN, and further preferably 240 to 500 mN.

The standard deviation of the frictional force between the writing feel improving film (writing feel improving layer surface) and the touch pen (stylus pen) during writing is preferably 10 to 60 mN, more preferably 14 to 45 mN, and particularly preferably 16 to 30 mN.

When either or all of the average value, maximum value, minimum value, and standard deviation of the above-described frictional force fall within the above-described ranges, the feeling of vibration transmitted to the hand holding the touch pen can be readily reproduced as the feeling of vibration obtained when writing on paper with a ballpoint pen. The above-described physical properties relating to frictional force can be measured by the method described in the Examples below.

The writing feel improving layer surface of the writing feel improving film according to the present disclosure is excellent in scratch resistance. Preferably, there is no change in appearance when the scratch resistance is evaluated using steel wool. Specifically, when the surface of the writing feel improving layer is rubbed at a load of 250 g/cm² using #0000 steel wool to reciprocate it ten times within a length of 10 cm in accordance with JIS K5600-5-10, it is preferred that no scratches be generated on the surface. As a result, when used on the surface of a display, such as a touch panel, excellent surface protection properties are exhibited, and the aesthetic appearance of the touch panel can be well maintained.

The scratch resistance can be evaluated by the method described in the Test Examples described below.

The pencil hardness of the writing feel improving film (writing feel improving layer surface) according to the present disclosure is preferably H or more, more preferably 2H or more, particularly preferably 3H or more, and further preferably 4H or more. The pencil hardness is usually 9H or less, preferably 7H or less, and more preferably 5H or less. By having this hardness, the writing feel improving film has excellent scratch resistance and exhibits excellent surface protection properties when used on the surface of a display such as a touch panel. In particular, the surface is less susceptible to scratches so that the aesthetic appearance of the touch panel can be well maintained.

Pencil hardness can be measured using a pencil scratch hardness tester in accordance with JIS K5600.

The total luminous transmittance (%) of the writing feel improving film according to the present disclosure is preferably 80% or more, more preferably 85% or more, and particularly preferably 90% or more. This makes the writing feel improving film excellent in transparency, and when applied to a touch panel, it can provide favorable image visibility. The upper limit of total luminous transmittance is usually 100%.

Total luminous transmittance can be measured using a haze meter in accordance with JIS K 7361-1.

The haze (%) of the writing feel improving film (writing feel improving layer surface) of the present disclosure is preferably 0 to 50%, more preferably 1 to 40%, particularly preferably 5 to 30%, and further preferably 10 to 22%. This makes the writing feel improving film excellent in transparency, and when applied to a touch panel, it can provide favorable image visibility.

Haze can be measured using a haze meter in accordance with JIS K 7136:2000.

### 2) Protective Film

In the protective film-equipped writing feel improving film according to the present disclosure, the protective film has the role of preventing the surface of the writing feel improving film surface from being scratched or stained.

The protective film may consist of a protective film base material layer or have a protective film base material layer and an adhesive layer.

### (1) Protective Film Base Material Layer

The material for the protective film base material layer according to the present embodiment is not particularly limited, and examples thereof include conventionally known materials used as protective film base material layers for optical films. Specifically, the same materials as those exemplified as the writing feel improving film base material layer can be mentioned.

Among these, from the viewpoints of ease of handling, availability, and the ease with which the effects of the present disclosure can be obtained, a polyethylene terephthalate film, a polybutylene terephthalate film, a polyethylene naphthalate film, a polycarbonate film, a polypropylene film, a polyimide film, a polyetherimide film, a polymethylpentene film, a polyphenylene sulfide film, and a liquid crystal polymer film are preferable, and a polyethylene terephthalate film, a polypropylene film, and a polycarbonate film are more preferable.

The protective film base material layer may be a single layer consisting of one of these films or a laminate of two or more of these films.

The protective film base material layer may be subjected to a surface treatment such as an oxidation method or a roughening method, or a primer treatment, as described above in the section on the writing feel improving film base material layer. These surface treatment methods are appropriately selected depending on the type of protective film base material layer or the like.

The thickness of the protective film base material layer is appropriately set in consideration of workability, cost, and the like. The thickness of the protective film base material layer is preferably 10 to 300 μm, more preferably 20 to 200 μm, particularly preferably 25 to 150 μm, further preferably 30 to 120 μm, and most preferably 35 to 110 μm. This makes it easier to satisfy the relational expression relating to the linear expansion coefficients α and β and also makes it easier for the delamination force described later to fall within the specific range.

### (2) Adhesive Layer

In a case in which the protective film has an adhesive layer, the base material layer for the protective film and the writing feel improving film can be adhered more readily and firmly via the adhesive layer.

Any adhesive that is generally used for optical film application can be used as an adhesive that constitutes the adhesive layer, and examples thereof include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. The adhesive may be of the emulsion type, solvent type, or solventless type. Furthermore, the adhesive may or may not have a crosslinked structure.

Among these, from the viewpoints of exhibiting the desired adhesiveness and excellent optical properties and durability, an acrylic-based adhesive containing a (meth)acrylic acid ester polymer as a base polymer is preferable, and an acrylic-based adhesive containing a (meth)acrylic acid ester polymer as a base polymer and having a crosslinked structure is more preferable. Herein, the term “polymer” also includes the concept of “copolymer.”

The monomer units constituting the above-described (meth)acrylic acid ester polymer can be appropriately adjusted from the viewpoints of transparency, adhesive strength, and the like. In particular, preferably, the polymer contains a (meth)acrylic acid alkyl ester and a monomer having a reactive functional group in the molecule (reactive functional group-containing monomer).

The (meth)acrylic acid ester polymer can exhibit preferable adhesiveness by containing a (meth)acrylic acid alkyl ester as a monomer unit constituting the polymer. As the (meth)acrylic acid alkyl ester, a (meth)acrylic acid alkyl ester having an alkyl group with 1 to 20 carbon atoms is preferable. The alkyl group may be linear or branched or have a cyclic structure.

Examples of a (meth)acrylic acid alkyl ester having an alkyl group with 1 to carbon atoms include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, stearyl (meth)acrylate, cyclohexyl (meth)acrylate, isobornyl (meth)acrylate, and adamantyl (meth)acrylate. Among these, from the viewpoint of facilitating the adjustment of the delamination force to a desired value described later, methyl (meth)acrylate and 2-ethylhexyl (meth)acrylate are preferable. These may each be used alone or two or more types may also be used in combination.

The (meth)acrylic acid ester polymer preferably contains, as a monomer unit constituting the polymer, an alkyl (meth)acrylate in an amount of 30% to 99.9% by mass, particularly preferably 50% to 99.5% by mass, and further preferably 70% to 99% by mass based on all monomer units. When the value is within this range, the delamination force described later can be readily adjusted to a desired value.

The (meth)acrylic acid ester polymer contains a reactive functional group-containing monomer as a monomer unit constituting the polymer so that it reacts with a crosslinking agent described below via the reactive functional group derived from the reactive functional group-containing monomer, thereby forming a crosslinked structure (three-dimensional network structure). Thus, an adhesive having the desired cohesive strength can be obtained.

Preferred examples of the reactive functional group-containing monomer include a monomer having a hydroxy group in the molecule (hydroxy group-containing monomer), a monomer having a carboxy group in the molecule (carboxy group-containing monomer), and a monomer having an amino group in the molecule (amino group-containing monomer). Among these, from the viewpoint of ease of adjusting the crosslink density and of obtaining an adhesive having the desired cohesive strength and from the viewpoint of the delamination force described below, hydroxyl group-containing monomers or carboxyl group-containing monomers are preferable. These reactive functional group-containing monomers may each be used alone or two or more types may also be used in combination.

Examples of a hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Of the above, (meth)acrylic acid hydroxyalkyl esters having a hydroxyalkyl group with 1 to 4 carbon atoms are preferable. These may each be used alone or two or more types may also be used in combination.

Examples of a carboxy group-containing monomer include ethylenically unsaturated carboxylic acids such as acrylic acid, methacrylic acid, crotonic acid, maleic acid, itaconic acid, and citraconic acid. Among these, acrylic acid is preferable from the viewpoint of readily satisfying the delamination force described below. These may each be used alone or two or more types may also be used in combination.

The (meth)acrylic acid ester polymer contains, as a monomer unit constituting the polymer, a reactive functional group-containing monomer in an amount of preferably 0.1% to 20% by mass, more preferably 0.5% to 10% by mass, and particularly preferably 0.8% to 3% by mass based on all monomer units. This makes it easier for the (meth)acrylic acid ester polymer to undergo the desired crosslinking reaction with a crosslinking agent. As a result, the resulting adhesive tends to have excellent cohesive strength, making it easier to adjust the delamination force described later to a desired value.

The (meth)acrylic acid ester polymer may further contain other monomers as a monomer constituting the polymer. Examples of the other monomers include alicyclic structure-containing (meth)acrylic acid esters such as glycidyl (meth)acrylate, dicyclopentanyl (meth)acrylate, adamantyl (meth)acrylate, isobornyl (meth)acrylate, dicyclopentenyl (meth)acrylate, and dicyclopentenyloxyethyl (meth)acrylate; alkoxyalkyl (meth)acrylic acid esters such as methoxyethyl (meth)acrylate and ethoxyethyl (meth)acrylate; non-crosslinkable acrylamides such as acrylamide and methacrylamide; non-crosslinkable (meth)acrylic acid esters having a tertiary amino group such as N,N-dimethylaminoethyl (meth)acrylate and N,N-dimethylaminopropyl (meth)acrylate; vinyl acetate; and styrene. Among these, from the viewpoint of the cohesive strength of the resulting (meth)acrylic acid ester polymer (A) and the delamination force described below, glycidyl (meth)acrylate is preferable, and glycidyl methacrylate is particularly preferable. These may each be used alone or two or more types may also be used in combination.

The (meth)acrylic acid ester polymer contains, as a monomer unit constituting the polymer, another monomer in an amount of preferably 0.1% to 10% by mass, more preferably 0.2% to 5% by mass, and further preferably 0.3% to 1% by mass based on all monomer units. As a result, the resulting adhesive tends to have excellent cohesive strength, making it easier to adjust the delamination force described later to a desired value.

The polymerization mode of the (meth)acrylic acid ester polymer in the present embodiment may be a random polymer or a block polymer. The acrylic-based polymer can be obtained by polymerizing the above-described monomers by an ordinary method. For example, it can be prepared by polymerization using an emulsion polymerization method, a solution polymerization method, a suspension polymerization method, a bulk polymerization method, an aqueous solution polymerization method, or the like. Among these, from the viewpoints of stability during polymerization and ease of handling during use, preparation by solution polymerization in an organic solvent is preferable.

The weight average molecular weight of the (meth)acrylic acid ester polymer is preferably 100,000 to 3,000,000, more preferably 300,000 to 2,000,000, particularly preferably 450,000 to 1,500,000, and further preferably 600,000 to 1,000,000. As a result, the resulting adhesive tends to have excellent cohesive strength, making it easier to adjust the delamination force described later to a desired value.

The adhesive composition according to the present embodiment may contain one type of the above-described (meth)acrylic acid ester polymer, or may contain two or more types. Moreover, the adhesive composition according to the present embodiment may contain another (meth)acrylic acid ester polymer in addition to the above-described (meth)acrylic acid ester polymer.

The crosslinking agent crosslinks the (meth)acrylic acid ester polymer by heating the adhesive composition, making it possible to form an excellent three-dimensional network structure. This improves the cohesive strength of the resulting adhesive, making it easier to adjust the delamination force described later to a desired value.

Examples of the crosslinking agent are preferably those which react with the reactive functional group possessed by the (meth)acrylic acid ester polymer, and examples thereof include isocyanate-based crosslinking agents, epoxy-based crosslinking agents, amine-based crosslinking agents, melamine-based crosslinking agents, aziridine-based crosslinking agents, hydrazine-based crosslinking agents, aldehyde-based crosslinking agents, oxazoline-based crosslinking agents, metal alkoxide-based crosslinking agents, metal chelate-based crosslinking agents, metal salt-based crosslinking agents, and ammonium salt-based crosslinking agents.

Among the above-described examples of the crosslinking agent, an isocyanate-based crosslinking agent, an epoxy-based crosslinking agent, or an aziridine-based crosslinking agent can preferably be used from the viewpoint of ease in reacting with the reactive functional group possessed by the (meth)acrylic acid ester polymer, and from the viewpoint of ease in adjusting the delamination force described later to a desired value. The crosslinking agents can each be used alone or two or more types can also be used in combination.

In a case in which the adhesive composition contains a crosslinking agent and a (meth)acrylic acid ester polymer, the content of the crosslinking agent in the adhesive composition is preferably 0.01 to 5 parts by mass, more preferably 0.1 to 4 parts by mass, particularly preferably 0.5 to 3 parts by mass, and further preferably 1 to 2 parts by mass with respect to 100 parts by mass of the (meth)acrylic acid ester polymer. This allows the resulting adhesive to exhibit more excellent cohesive strength and also makes it easier to adjust the delamination force described later to a desired value.

The adhesive layer may also contain other components depending on the purpose.

Examples of other components include a tackifier, a plasticizer, an antistatic agent, an ultraviolet absorber, a silane coupling agent, a rust inhibitor, an antioxidant, a light stabilizer, a softener, and a refractive index adjuster. The polymerization solvent and dilution solvent described below are not included in the additives constituting the adhesive composition.

In a case in which the adhesive composition contains a plasticizer, the content of the plasticizer in the adhesive composition is preferably 0.1 to 50 parts by mass, more preferably 1 to 35 parts by mass, particularly preferably 4 to 20 parts by mass, and further preferably 8 to 15 parts by mass with respect to 100 parts by mass of the (meth)acrylic acid ester polymer. This allows the resulting adhesive to exhibit more excellent cohesive strength and also makes it easier to adjust the delamination force described later to a desired value.

The thickness of the adhesive layer is not particularly limited, but is preferably 3 to 300 μm, more preferably 5 to 200 μm, particularly preferably 10 to 100 μm, further preferably 15 to 60 μm, and most preferably 20 to 35 μm. This makes it easier to satisfy the relational expression relating to the linear expansion coefficients α and β and also makes it easier for the delamination force described later to fall within the specific range.

### (3) Protective Film

The method of producing a protective film having an adhesive layer is not particularly limited. For example, a protective film can be formed by applying a composition for forming an adhesive layer to a desired thickness on a protective film base material layer by a known coating method and drying the resulting coating film.

The composition for forming an adhesive layer usually contains a base polymer, a solvent, a crosslinking agent, and optionally fine particles, a tackifier, a plasticizer, an antistatic agent, an ultraviolet absorbing agent, and the like.

The protective film-equipped writing feel improving film of the present disclosure is required to have a linear expansion coefficient β (×10⁻⁵/K) of the protective film satisfying the formula: −6.5<(α−β)<6.5 in relation to the linear expansion coefficient α (×10⁻⁵/K) of the writing feel improving film as described below.

In other words, the protective film used must have a linear expansion coefficient that satisfies the above formula in relation to the writing feel improving film used.

Specifically, the linear expansion coefficient β (×10⁻⁵/K) of the protective film is not particularly limited as long as it satisfies the formula: −6.5<(α−β)<6.5 in relation to the linear expansion coefficient α of the writing feel improving film described above, but is usually more than 0 and not more than 50 (×10⁻⁵/K), preferably 1 to 15 (×10⁻⁵/K), more preferably 1.3 to 10 (×10⁻⁵/K), and particularly preferably 1.5 to 8 (×10⁻⁵/K). This makes it easier to satisfy the above-described formula.

The linear expansion coefficient of the protective film can be determined by measuring the longitudinal expansion and contraction of a test piece having a width of 4.5 mm and a length of 15 mm at a temperature increase rate of 5° C./min using a thermomechanical analyzer and calculating the linear expansion coefficient (×10⁻⁵/K) in a range of 30° C. to 70° C.

The tensile modulus of the protective film is usually 10 to 3000 (MPa).

When the tensile modulus of the protective film is within this range, the protective film tends to be readily peeled off from the writing feel improving film. In addition, it facilitates excellent surface protection properties to be exhibited, and thus, the quality of the writing feel improving film can be maintained at an excellent level.

The tensile modulus is a value measured in accordance with JIS K7127: 1999.

### 3) Protective Film-Equipped Writing Feel Improving Film

The protective film-equipped writing feel improving film of the present disclosure is formed by laminating a protective film on at least one surface of the writing feel improving film.

In a case in which the protective film has an adhesive layer, the protective film is laminated on the writing feel improving film so that at least one surface of the writing feel improving film is in contact with the adhesive layer.

The protective film-equipped writing feel improving film of the present disclosure may be in a long shape (strip-like) or a rectangular shape (sheet-like).

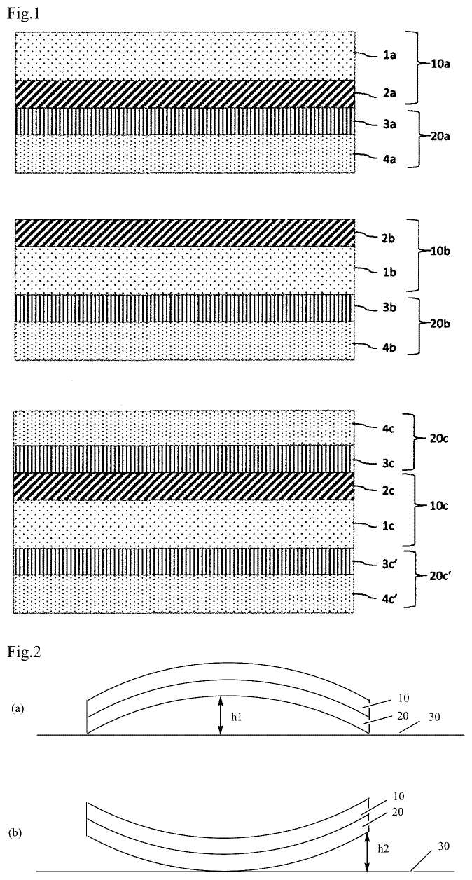

FIG. 1 illustrates a schematic diagram showing the layer structure of the protective film-equipped writing feel improving film of the present disclosure. FIG. 1 illustrates an example of the layer structure of the protective film-equipped writing feel improving film when the protective film has an adhesive layer.

Portion (a) of FIG. 1 is an example in which a writing feel improving film 10a is laminated on a protective film 20a so that a writing feel improving layer 2a is in contact with an adhesive layer 3a of the protective film 20a. Portion (b) of FIG. 1 is an example in which a writing feel improving film 10b is laminated on a protective film 20b so that a writing feel improving film base material layer 1b is in contact with an adhesive layer 3b of the protective film 20a. Portion (c) of FIG. 1 is an example in which a protective film 20a is laminated on a writing feel improving layer 2c of a writing feel improving film 10c so that the writing feel improving layer 2c is in contact with an adhesive layer 3c of the protective film 20c, and a protective film 20c′ is laminated on a writing feel improving film base material layer 1c so that the writing feel improving film base material layer 1c is in contact with an adhesive layer 3c′ of the protective film 20c.

Specific examples of the layer structure of the protective film-equipped writing feel improving film of the present disclosure include the following:
(1) protective film base material layer/writing feel improving film base material layer/writing feel improving layer;
(2) protective film base material layer/adhesive layer/writing feel improving film base material layer/writing feel improving layer;
(3) writing feel improving film base material layer/writing feel improving layer/protective film base material layer;
(4) writing feel improving film base material layer/writing feel improving layer/adhesive layer/protective film base material layer;
(5) protective film base material layer 1/writing feel improving film base material layer/writing feel improving layer/protective film base material layer 2;
(6) protective film base material layer 1/adhesive layer 2/writing feel improving film base material layer/writing feel improving layer/protective film base material layer 2;
(7) protective film base material layer 1/writing feel improving film base material layer/writing feel improving layer/adhesive layer 2/protective film base material layer 2;
(8) protective film base material layer 1/adhesive layer 1/writing feel improving film base material layer/writing feel improving layer/adhesive layer 2/protective film base material layer 2.

In a case in which a protective film is laminated on both sides of the writing feel improving film of the protective film-equipped writing feel improving film of the present disclosure, the two protective films may be the same or different.

Among the above, a protective film-equipped writing feel improving film in which the protective film is laminated on the writing feel improving layer of the writing feel improving film is preferred because the writing feel improving layer is directly protected, facilitating the maintenance of the quality of the writing feel improving layer.

The protective film-equipped writing feel improving film can be produced by stacking the writing feel improving film and the protective film and pressing them together (laminating them).

In a case in which the protective film has an adhesive layer, the protective film and the writing feel improving film may be laminated by a known method so that the adhesive layer is in contact with the writing feel improving film.

As described above, given that a linear expansion coefficient of the writing feel improving film is α (×10⁻⁵/K) and a linear expansion coefficient of the protective film is β (×10⁻⁵/K), the following formula is satisfied: −6.5<(α−β)<6.5 in the protective film-equipped writing feel improving film of the present disclosure. The protective film-equipped writing feel improving film of the present disclosure satisfies the formula, which is preferably −6.0<(α−β)<6.0, more preferably −3.0<(α−β)<3.0, particularly preferably −1.0<(α−β)<1.0, and further preferably −0.5<(α−β)<0.5.

In a case in which the (α−β) value of the protective film-equipped writing feel improving film is-6.5 or less or 6.5 or more, the film may curl due to temperature changes when the protective film-equipped writing feel improving film is exposed to high temperatures (40° C. to 60° C.) for a long period during storage or transportation or processed under high temperatures (50° C. to 90° C.) during processing, which may cause the quality of the writing feel improving film to deteriorate (loss of the function of improving the writing feel with a touch pen on the writing feel improving film).

Since the α and β values satisfy a relationship as described above for the protective film-equipped writing feel improving film of the present disclosure, curling due to temperature changes during storage, transportation, processing, or the like of the protective film-equipped writing feel improving film is effectively controlled. As a result, this makes it possible to maintain the quality of the writing feel improving film.

It is possible to confirm that the curling of the protective film-equipped writing feel improving film of the present disclosure due to temperature changes occurs less based on, for example, the fact that the occurring maximum curl height is generally 50 mm or less and preferably 40 mm or less even after a sample (A4 size) of the protective film-equipped writing feel improving film of the present disclosure is placed with the protective film side down in an oven maintained at 70° C. and left for 1 hour.

Here, the “maximum curl height” is the maximum vertical distance between the horizontal test stand and the protective film. As illustrated in FIG. 2A, in a case in which a mountain-shaped curl occurs, the maximum curl height is the distance (height) indicated by h1. As illustrated in FIG. 2B, in a case in which a valley-shaped curl occurs, the maximum curl height is the distance (height) indicated by h2.

In a case in which the protective film-equipped writing feel improving film has two protective films, as illustrated in portion (c) of FIG. 1 above, from the viewpoint of suppressing curling, preferably, the β of each of the two protective films satisfies the above requirement.

In other words, for the protective film-equipped writing feel improving film of the present disclosure, it is necessary to select and use a protective film having a linear expansion coefficient that satisfies the above formula in relation to the writing feel improving film used or to select and use a writing feel improving film having a linear expansion coefficient that satisfies the above formula in relation to the protective film used.

The protective film-equipped writing feel improving film of the present disclosure can be produced by, for example, preparing some protective films with various linear expansion coefficients β (×10⁻⁵/K) (step (i)), measuring the linear expansion coefficient α (×10⁻⁵/K) of a writing feel improving film on which the protective films are laminated (step (ii)), selecting a protective film that satisfies the formula: −6.5<(α−β)<6.5, and laminating (attaching) the writing feel improving film with the protective film to form the layer structures in portions (a) to (c) of FIG. 1.

For the protective film-equipped writing feel improving film of the present disclosure, the delamination force between the writing feel improving film and the protective film is preferably 800 mN/25 mm or less. Here, the “delamination force between the writing feel improving film and the protective film” means the delamination force between the writing feel improving layer surface of the writing feel improving film and the protective film and/or the delamination force between the base material layer surface of the writing feel improving film and the protective film. Details are provided below.

For the protective film-equipped writing feel improving film of the present disclosure, the delamination force between the writing feel improving layer surface of the writing feel improving film and the protective film is preferably 800 mN/25 mm or less, more preferably 500 mN/25 mm or less, particularly preferably 300 mN/25 mm or less, and further preferably 250 mN/25 mm or less.

In a case in which no protective film is laminated on the base material side of the writing feel improving film, from the viewpoint of peelability from the writing feel improving layer, the delamination force between the writing feel improving layer surface and the protective film is preferably 220 mN/25 mm or less, more preferably 200 mN/25 mm or less, particularly preferably 180 mN/25 mm or less, and most preferably 160 mN/25 mm or less. The lower limit of the delamination force between the writing feel improving film and the protective film is preferably 50 mN/25 mm or more, more preferably 80 mN/25 mm or more, and particularly preferably 100 mN/25 mm or more from the viewpoint of preventing problems such as the protective film accidentally lifting or peeling off from the writing feel improving film when exposed to temperature changes.

For the protective film-equipped writing feel improving film of the present disclosure, the delamination force between the base material layer surface of the writing feel improving film and the protective film is preferably 800 mN/25 mm or less, more preferably 500 mN/25 mm or less, particularly preferably 300 mN/25 mm or less, further preferably 200 mN/25 mm or less, and most preferably 170 mN/25 mm or less. The lower limit of the delamination force between the writing feel improving film and the protective film is preferably 50 mN/25 mm or more, more preferably 80 mN/25 mm or more, and particularly preferably 100 mN/25 mm or more from the viewpoint of preventing problems such as the protective film accidentally lifting or peeling off from the writing feel improving film when exposed to temperature changes.

By having such a delamination force, the occurrence of curling due to temperature changes during storage, transportation, processing, and the like can be more effectively controlled, the quality of the writing feel improving film can be maintained, and the protective film can be readily peeled and removed from the writing feel improving film when in use.

The delamination force between the writing feel improving film and the protective film can be measured by the methods described in the Examples.

The protective film-equipped writing feel improving film of the present disclosure can be used as a writing feel improving film that constitutes the outermost layer of a touch panel (image display device with position detection function) on which a touch pen is used when the protective film is removed by peeling from the writing feel improving film.

Specifically, the writing feel improving film is laminated on the cover material of a display body module such as a liquid crystal (LCD) module, a light emitting diode (LED) module, or an organic electroluminescence (organic EL) module or the cover material of a touch panel having a touch sensor or the like so that the cover material is in contact with the surface of the writing feel improving film base material layer. The writing feel improving film may be attached via a binder layer.

The touch pen used with the writing feel improving film is not particularly limited, and examples thereof include those having a polyacetal pen tip, those having a hard felt pen tip, and those having an elastomer pen tip.

It should be appreciated that the embodiments heretofore explained are described to facilitate understanding of the present disclosure and are not described at all to limit the present disclosure. It is therefore intended that the elements disclosed in the above embodiments include all design changes and equivalents to fall within the technical scope of the present disclosure.

For example, a different layer may be laminated on the protective film-equipped writing feel improving film of the present disclosure. The other layers include a binder layer, a release film, and the like, which are laminated on the writing feel improving film base material layer.

In a case in which it is herein described as “X to Y” (X and Y are arbitrary numbers), it includes the meaning of “from X to Y,” as well as the meaning of “preferably larger than X” or “preferably smaller than Y” unless otherwise specified. In a case in which it is herein described as “X or more” (X is any number), it also includes the meaning of “preferably greater than X” unless otherwise specified. In a case in which it is described as “Y or less” (Y is any number), it also includes the meaning of “preferably smaller than Y” unless otherwise specified.

### EXAMPLES

Hereinafter, the present disclosure described further specifically with reference to examples and the like but the scope of the present disclosure is not limited to these examples and the like.

### (Production Example 1) Preparation of Composition for Forming Writing Feel Improving Layer

A composition for forming a writing feel improving layer was prepared by mixing 100 parts by mass of an active energy ray-curable component containing polyfunctional urethane acrylate (product name: “OPSTAR Z7530” available from ARAKAWA CHEMICAL INDUSTRIES, LTD.) (expressed as a solid content equivalent, the same applies below to other components other than the solvent), 9.0 parts by mass of silicone fine particles (Tospearl 1100 available from Momentive Performance Materials Japan, average particle diameter: 11.0 μm, genuinely spherical), 1.0 parts by mass of a fluorine-based surface conditioner (Megafac RS-90 available from DIC), 0.3 parts by mass of a silicone-based surface conditioner (SH28, polydimethylpolysiloxane available from Dow Toray Co., Ltd.), and 85.5 parts by mass of 1-methoxy-2-propanol as a solvent.

### (Production Example 2) Preparation of Composition for Forming Adhesive Layer

A (meth)acrylic acid ester polymer was prepared by copolymerizing 70 parts by mass of 2-ethylhexyl acrylate, 28.6 parts by mass of methyl acrylate, 0.3 parts by mass of glycidyl methacrylate, and 1.1 parts by mass of acrylic acid. The molecular weight of the resulting (meth)acrylic acid ester polymer was measured by the method described below. The weight average molecular weight (Mw) was found to be 800,000.

The weight average molecular weight (Mw) is a polystyrene-equivalent weight average molecular weight measured by gel permeation chromatography (GPC) under the following conditions (GPC measurement).

### (Measurement Conditions)

GPC measurement device: HLC-8020 available from Tosoh Corporation
GPC columns (passed in the following order) available from Tosoh Corporation
   TSK guard column HXL-H
   TSK gel GMHXL (×2)
   TSK gel G2000HXL
Measurement solvent: Tetrahydrofuran
Measurement temperature: 40° C.

A composition for forming an adhesive layer was prepared by mixing 100 parts by mass of the (meth)acrylic acid ester polymer (expressed as a solid content equivalent, the same applies below to other components other than the solvent) obtained above, 10.0 parts by mass of dibutoxyethoxyethyl adipate as a plasticizer, 1.9 parts by mass of an aziridine-based crosslinking agent (BXX-5134 available from TOYOCHEM CO., LTD.) as a cross-linker, and 87 parts by mass of toluene as a solvent.

### (Production Example 3) Production of Writing Feel Improving Film a

The composition for forming a writing feel improving layer obtained in Production Example 1 was applied to a polycarbonate/polymethyl methacrylate (PC/PMMA) laminated film [AW-10SU, thickness: 200 μm (thickness ratio: PC/PMMA=about 2:1), linear expansion coefficient: 7.66×10⁻⁵/K, tensile modulus: 1990 MPa, available from Wavelock Advanced Technology Co., Ltd.] as a writing feel improving film base material layer with a Mayer bar, thereby forming a coating film having a thickness of 7 μm. The coating film was placed in an oven maintained at 70° C. for 1 minute for drying.

Next, using an ultraviolet irradiation device (Eigrantage ECS-401GX type available from EYE GRAPHICS COMPANY), ultraviolet irradiation was performed using a high-pressure mercury lamp as a light source under the following irradiation conditions to harden the coating film, thereby preparing a writing feel improving film a.

### (Ultraviolet Irradiation Conditions)

Lamp power: 2 kW
Conveyor speed: 4.23 m/min
Illuminance: 240 mW/cm²
Light amount: 307 mJ/cm²

### (Production Example 4) Production of Writing Feel Improving Film b

A writing feel improving film b was produced in the same manner as in Production Example 3, except that a polyethylene terephthalate (PET) film (Lumirror U403, thickness: 188 μm, linear expansion coefficient: 1.68×10⁻⁵/K, tensile modulus: 214 MPa, available from TORAY INDUSTRIES, INC.) was used instead of the PC/PMMA laminated film in Production Example 3.

The linear expansion coefficient α (×10⁻⁵/K), total luminous transmittance (%), and haze (%) were measured by the methods described below for the resulting writing feel improving films a and b.

In addition, the frictional force and pencil hardness of the surface of the writing feel improving layer were measured by the methods described below for the resulting writing feel improving films a and b to evaluate the scratch resistance.

### (Linear Expansion Coefficient)

Using a thermomechanical analyzer (TMA4000SA available from Bruker AXS), the expansion and contraction in the longitudinal direction of a test piece having a width of 4.5 mm and a length of 15 mm was measured at a temperature increase rate of 5° C./min, and the linear expansion coefficient α (×10⁻⁵/K) was calculated in a range of 30° C. to 70° C.

The results are listed in Table 1.

### (Total Luminous Transmittance)

The total luminous transmittance (%) of each obtained writing feel improving film was measured in accordance with JIS K 7361-1 using a haze meter (NDH-5000 available from NIPPON DENSHOKU INDUSTRIES CO., LTD.) by irradiating light from the writing feel improving layer side after blank correction.

The total luminous transmittance of the writing feel improving film a was 90.4%, and the total luminous transmittance of the writing feel improving film b was 90.3%.

### (Haze)

The haze value (%) of each obtained writing feel improving film was measured in accordance with JIS K 7136-2000 using a haze meter (NDH-5000 available from NIPPON DENSHOKU INDUSTRIES CO., LTD.) by irradiating light from the writing feel improving layer side after blank correction.

The haze value of the writing feel improving film a was 20.4%, and the haze value of the writing feel improving film b was 20.2%.

### (Measurement of Frictional Force)

The frictional force during writing using the obtained writing feel improving films a and b and a stylus pen (product name “ACK-2003,” pen tip material: felt, pen tip diameter: 0.5 mm, available from Wacom Co., Ltd.) was measured under the following conditions using a static and dynamic friction measuring device (Tribomaster TL201 Ts, manufactured by Trinity Labs Co., Ltd.).

The writing feel improving film a had an average frictional force of 310 mN, a maximum frictional force of 350 mN, a minimum frictional force of 240 mN, and a standard deviation of the frictional force of 17 mN. The writing feel improving film b had an average frictional force of 300 mN, a maximum frictional force of 340 mN, a minimum frictional force of 230 mN, and a standard deviation of the frictional force of 18 mN.

### (Measurement Conditions)

Load: 200 g
Test length: 10 to 100 mm
Speed: 1.6 mm/s (vibration measurement conditions, dynamic friction coefficient measurement conditions)
Sampling pitch: 50 ms
Stylus pen tip angle: 45°

### (Pencil Hardness)

The pencil hardness of the surface on the writing feel improving layer side was measured in accordance with JIS K5600 using a pencil scratch hardness tester (product name “No. 553-M” available from YASUDA SEIKI SEISAKUSHO, LTD.) for the obtained writing feel improving films a and b.

The pencil hardness of both writing feel improving films a and b was 4H.

### (Scratch Resistance)

The surface on the writing feel improving layer side was rubbed at a load of 250 g/cm² using #0000 steel wool to reciprocate it ten times within a sliding distance of 10 cm in accordance with JIS K5600-5-10 for the writing feel improving films a and b. Thereafter, the surface on the writing feel improving layer side visually confirmed under a three-wavelength fluorescent lamp for the presence or absence of scratches and was evaluated according to the following criteria.
∘ (Excellent): No change was observed in the appearance of the writing feel improving layer (0 scratches were confirmed).
x (Poor): Changes were observed in the appearance of the writing feel improving layer (one or more scratches were confirmed).

As a result, both of the writing feel improving films a and b were rated as “o” indicating that they had excellent scratch resistance.

### Example 1

A protective film-equipped writing feel improving film having a layer structure similar to that illustrated in portion (a) of FIG. 1 was produced.

The composition for forming an adhesive layer obtained in Production Example 2 was applied to a protective film base material layer C (a polycarbonate (PC) film (thickness: 100 μm, linear expansion coefficient: 7.70 (×10⁻⁵/K))) using an applicator, by which a desired film thickness can be obtained, so as to give a film thickness of 30 μm, thereby forming a coating film of an adhesive layer. Thereafter, the coating film was dried in an oven maintained at 100° C. for 1 minute, thereby obtaining a protective film consisting of a protective film base material layer and an adhesive layer.

The linear expansion coefficient β (×10⁻⁵/K) of the protective film was measured by the method described above. The results are listed in Table 1.

Next, the adhesive layer surface of the protective film obtained above was attached to the writing feel improving layer surface of the writing feel improving film a obtained in Production Example 2, thereby producing a protective film-equipped writing feel improving film.

### Examples 2 to 4, Comparative Examples 1 and 2

Protective film-equipped writing feel improving films of Examples 2 to 4 and Comparative Examples 1 and 2 were produced in the same manner as in Example 1 in the aspects shown in Table 1.

In the table, protective film base material layers D and E are as follows.
D: Polypropylene (PP) film (thickness: 120 μm)
E: PET film (thickness: 38 μm)

### Example 5

The composition for forming an adhesive layer obtained in Production Example 2 was applied to a protective film base material layer E (PET film, thickness: 38 μm) using an applicator, by which a desired film thickness can be obtained, so as to give a film thickness of 23 μm in the same manner as in Example 1, thereby forming a coating film of an adhesive layer. Thereafter, the coating film was dried in an oven maintained at 100° C. for 1 minute, thereby obtaining a protective film consisting of a protective film base material layer E and an adhesive layer.

The adhesive layer surface of the protective film was attached to the writing feel improving layer surface side and the base material layer surface side of the writing feel improving film a, thereby producing a protective film-equipped writing feel improving film having the protective film/writing feel improving film/protective film constitution.

### Examples 6 and 7

Protective film-equipped writing feel improving films of Examples 6 and 7 were produced in the same manner as in Example 5 in the aspects shown in Table 2.

The linear expansion coefficients β1 and β2 (×10⁻⁵/K) of the protective film were measured by the method described above. The results are listed in Table 2.

The difference between the linear expansion coefficient α (×10⁻⁵/K) of the writing feel improving film and the linear expansion coefficient β (×10⁻⁵/K) of the protective film for each of the protective film-equipped writing feel improving films obtained in Examples 1 to 7 and Comparative Examples 1 and 2 are shown in Tables 1 and 2.

The delamination force between the protective film and the writing feel improving film was measured by the method described below for each of the protective film-equipped writing feel improving films obtained in Examples 1 to 7 and Comparative Examples 1 and 2.

In addition, a curling test was conducted as described below to evaluate the writing feel.

The results are listed in Tables 1 and 2.

### (Delamination Force)

The protective film-equipped writing feel improving films obtained in Examples 1 to 7 and Comparative Examples 1 and 2 were cut into test pieces having a width of 25 mm and a length of 110 mm. For the obtained test pieces, a tensile testing machine (TENSILON available from ORIENTEC CO., LTD.) was used to measure the delamination force (adhesive strength) (N/25 mm) when the protective film was peeled off from the surface of the writing feel improving layer side of the writing feel improving film under conditions of a peel speed of 300 mm/min and a peel angle of 180° in accordance with JIS Z0237: 2009.

In addition, for the protective film-equipped writing feel improving films obtained in Examples 5 to 7, the delamination force (adhesive strength) (N/25 mm) was measured when the protective film was peeled off from the surface of the base material side of the writing feel improving film using a method similar to that described above.

The results are listed in Tables 1 and 2.

### (Curling Test)

The obtained protective film-equipped writing feel improving films were each cut into an A4-size piece and placed in an oven maintained at 70° C. with the protective film side facing down. After they were left for 1 hour, the maximum height (mm) of the curl that occurred was measured.

In the table, a minus sign (−) indicates a curl with a direction in which a valley-shaped curl occurred on the protective film side. No minus sign (−) indicates a curl that the protective film side curled in a mountain shape.

### (Evaluation of Writing Feel)

Paper (product name “Campus Loose Leaf,” product model number: “NO-S816B,” size: B5, ruled width: B-ruled, 20 sheets stacked when used) and a ballpoint pen (product name “Orange EG 1.0,” oil-based ballpoint pen, pen tip diameter: 1.0 mm, available from BIC) were prepared. An evaluator wrote the letters “ABCDE” on the paper with the ballpoint pen.

Next, the protective film was peeled off from the writing feel improving layer of the protective film-equipped writing feel improving film after the curling test, and the film was attached to a glass plate (length: 70 mm, width: 150 mm, thickness: 1.2 mm) using double-sided tape so that the writing feel improving layer was exposed. An evaluator wrote the letters “ABCDE” on the surface of the writing feel improving layer using the stylus pen used in the frictional force measurement.

The writing feel (x) of actually writing on paper with the ballpoint pen was compared with the writing feel (y) of writing on the writing feel improving layer with the stylus pen, and the writing feel was evaluated according to the following criteria.

### (Evaluation Criteria)

∘ (Excellent): The writing feel (y) was very similar to the writing feel (x), with the feelings of vibration and resistance.
Δ (Fair): The writing feel (y) had slightly greater feelings of vibration and resistance than the writing feel (x).
x (Poor): The writing feel (y) was different from the writing feel (x) in terms of the feelings of vibration and resistance.

TABLE 1

| | | | | Protective film | | | | | | | |
|---|---|---|---|---|---|---|---|---|---|---|---|
| | Writing feel improving film | | | Adhesive | | | | | | | |
| | Base material | | Linear | layer | Base material | | Linear | Delami- | | Maximum | Writing |
| | | Thick- | expansion | Thick- | | Thick- | expansion | nation | | curl | feel |
| | | ness | coefficientα | ness | | ness | coefficientβ | force | α − β | height | evaluation |
| | Type | (μm) | (×10⁻⁵/K) | (μm) | Type | (μm) | (×10⁻⁵/K) | (mN/25 mm) | (×10⁻⁵/K) | (mm) | result |
| Example 1 | A | 200 | 7.53 | 30 | C | 100 | 7.82 | 118 | −0.29 | 0 | ◯ |
| Example 2 | A | 200 | 7.53 | 23 | E | 38 | 2.00 | 155 | 5.53 | −22 | ◯ |
| Example 3 | B | 188 | 1.66 | 30 | C | 100 | 7.82 | 118 | −6.16 | −40 | ◯ |
| Example 4 | B | 188 | 1.66 | 23 | E | 38 | 2.00 | 155 | −0.34 | 0 | ◯ |
| Comparative | A | 200 | 7.53 | 25 | D | 120 | 21.1 | 180 | −13.57 | 85 | Δ |
| Example 1 | | | | | | | | | | | |
| Comparative | B | 188 | 1.66 | 25 | D | 120 | 21.1 | 180 | −19.44 | 100 | Δ |
| Example 2 | | | | | | | | | | | |

TABLE 2

| | | | | | | | Writing feel | | |
|---|---|---|---|---|---|---|---|---|---|
| | Protective film 20c | | | | | | improving film 10c | | |
| | Adhesive | | | Linear | | | | | Linear |
| | layer | Base material | | expansion | Delami- | | Base material | | expansion |
| | Thick- | | Thick- | coeffi- | nation | | | Thick- | coeffi- |
| | ness | | ness | cientβ1 | force | α − β1 | | ness | cientα |
| | (μm) | Type | (μm) | (×10⁻⁵/K) | (mN/25 mm) | (×10⁻⁵/K) | Type | (μm) | (×10⁻⁵/K) |
| Example 5 | 23 | E | 38 | 2.00 | 155 | 5.53 | A | 200 | 7.53 |
| Example 6 | 30 | C | 100 | 7.82 | 118 | −6.16 | B | 188 | 1.66 |
| Example 7 | 23 | E | 38 | 2.00 | 155 | −0.34 | B | 188 | 1.66 |

| | Protective film 20c | | | | | | | |
|---|---|---|---|---|---|---|---|---|
| | | | | Linear | | | | |
| | | Base material | | expansion | Delami- | | Maximum | Writing |
| | Thick- | | Thick- | coeffi- | nation | | curl | feel |
| | ness | | ness | cientβ2 | force | α − β2 | height | evaluation |
| | (μm) | Type | (μm) | (×10⁻⁵/K) | (mN/25 mm) | (×10⁻⁵/K) | (mm) | result |
| Example 5 | 23 | E | 38 | 2.00 | 240 | 5.53 | 0 | ◯ |
| Example 6 | 30 | C | 100 | 7.82 | 223 | −6.16 | 5 | ◯ |
| Example 7 | 30 | C | 100 | 7.82 | 223 | −6.16 | 38 | ◯ |

From Tables 1 and 2, it can be seen that the protective film-equipped writing feel improving films of Examples 1 to 7, in which the (α−β) value is more significant than −6.5 and less than 6.5, have a maximum curl height of 40 mm or less, and curling due to heat is suppressed.

Further, the writing feel is also excellent, and it can also be seen that the quality of the writing feel improving layer is maintained.

In contrast, in Comparative Examples 1 and 2, the maximum curl height was 85 mm or more, indicating that curling occurs to a large extent by heat. As a result, the writing feel is poor and curling occurs, impairing the quality of the writing feel improving layer.

### REFERENCE SIGNS LIST

1a, 1b, 1c Writing feel improving film base material layer
2a, 2b, 2c Writing feel improving layer
3a, 3b, 3c, 3c′ Adhesive layer
4a, 4b, 4c, 4c′ Protective film base material layer
10a, 10b, 10c Writing feel improving film
20a, 20b, 20c, 20c′ Protective film
30 Test stand
h1, h2 Maximum curl height

1. A protective film-equipped writing feel improving film which is formed by laminating a protective film on at least one surface of a writing feel improving film having a writing feel improving film base material layer and a writing feel improving layer,
wherein given that a linear expansion coefficient of the writing feel improving film is α (×10⁻⁵/K) and a linear expansion coefficient of the protective film is β (×10⁻⁵/K), the following formula is satisfied: −6.5<(α−β)<6.5.

2. The protective film-equipped writing feel improving film according to claim 1, wherein the protective film is laminated on a surface of the writing feel improving layer of the writing feel improving film.

3. The protective film-equipped writing feel improving film according to claim 1, wherein the protective film has an adhesive layer and a protective film base material layer, and at least one surface of the writing feel improving film is laminated on the adhesive layer of the protective film so as to be in contact therewith.

4. The protective film-equipped writing feel improving film according to claim 1, wherein given that a linear expansion coefficient of the writing feel improving film is α (×10⁻⁵/K) and a linear expansion coefficient of the protective film is β (×10⁻⁵/K), the following formula is satisfied: −1.0<(α−β)<1.0.

5. The protective film-equipped writing feel improving film according to claim 1, wherein the linear expansion coefficient α (×10⁻⁵/K) of the writing feel improving film is 1.5 to 8.0 (×10⁻⁵/K).

6. The protective film-equipped writing feel improving film according to claim 1, wherein a delamination force between the writing feel improving film and the protective film is 800 mN/25 mm or less.

7. The protective film-equipped writing feel improving film according to claim 2, wherein the protective film has an adhesive layer and a protective film base material layer, and at least one surface of the writing feel improving film is laminated on the adhesive layer of the protective film so as to be in contact therewith.

8. The protective film-equipped writing feel improving film according to claim 2, wherein given that a linear expansion coefficient of the writing feel improving film is α (×10⁻⁵/K) and a linear expansion coefficient of the protective film is β (×10⁻⁵/K), the following formula is satisfied: −1.0<(α−β)<1.0.

9. The protective film-equipped writing feel improving film according to claim 2, wherein the linear expansion coefficient α (×10⁻⁵/K) of the writing feel improving film is 1.5 to 8.0 (×10⁻⁵/K).

10. The protective film-equipped writing feel improving film according to claim 2, wherein a delamination force between the writing feel improving film and the protective film is 800 mN/25 mm or less.
